(19) United States
(12) Patent Application Publication
(10) Pub. No.: US 2025/0182618 A1
(43) Pub. Date: Jun. 5, 2025

(54) INTERSECTION SIGNAL PHASING SYSTEM BASED ON DISTANCE BETWEEN INTERSECTIONS

(71) Applicant: DONGRIM TNS CO.,LTD, Ulsan (KR)

(72) Inventors: Tak Soo LEE, Seoul (KR); Sam Hyun SUNG, Goyang-si (KR)

(21) Appl. No.: 18/724,688

(22) PCT Filed: Dec. 26, 2022
(86) PCT No.: PCT/KR2022/021297

§ 371 Date: Feb. 11, 2025

(30) Foreign Application Priority Data
Dec. 31, 2021 (KR) 10-2021-0193952

(51) Int. Cl. G08G 1/082

(52) U.S. Cl. CPC G08G 1/082

(57) ABSTRACT

It is a technology for controlling efficient traffic flow by adjusting the current value of the first signal lamp installed on the first intersection and the second signal lamp installed on the second intersection spaced 450-550 m from the first intersection.

### TECHNICAL FIELD

The present invention relates to a field of traffic communication, and more particularly, to an intersection signal phasing system based on a distance between intersections.

### BACKGROUND ART

Signal control at intersections (crossroad) on urban arterial roads is usually operated based on a signal phasing system that involves going straight ahead in both directions first and then turning left, that is, a straight ahead-first-and-then separate signal. During commuting to and from work, a signal period is adjusted and operated in a direction in which traffic volume increases.

However, the straight ahead-first-and-then separate signal has limitations in that it cannot satisfy an interoperation system between both directions (upbound and downbound) by a separation distance between intersections (separation time) and an intersection traffic signal lighting interval (OFFset). That is, since the existing traffic system considers only the signal period according to the number of vehicles generated during congestion, the interoperability of a distance between intersections is ignored and congestion is not easily solved, which is problematic.

### DISCLOSURE OF THE INVENTION

### Technical Problem

The present invention provides a signal phasing system that maximizes an interoperation width between both directions, and adjusts the signal period based on the distance between intersections, and displays straight ahead and left turn signals as a simultaneous signal, thereby capable of resolving vehicle congestion in congested areas.

### Technical Solution

In accordance with an embodiment of the present invention, an intersection signal system based on a distance between intersections includes a first intersection 110, a second intersection 210 located 450 to 550 m away from the first intersection 110 in the other direction, first traffic lights 110S provided in the first intersection 110; and second traffic lights 210S provided in the second intersection 210, in which, in the first traffic lights 110S, a first signal indication 111 simultaneously indicates both a straight ahead signal and a left turn signal along the other direction, a second signal indication 112 simultaneously indicates both a straight ahead signal and a left turn signal along one direction, a third signal indication 113 simultaneously indicates both a straight ahead signal and a left turn signal along a downward direction, and a fourth signal indication 114 simultaneously indicates both a straight ahead signal and a left turn signal in an upward direction, in which signal indication values of the first signal indication 111, second signal indication 112, third signal indication 113, and fourth signal indication 114 are 35 to 37 seconds, 43 to 45 seconds, 19 to 21 seconds, and 19 to 21 seconds, respectively, in which in the second traffic lights 210S, a first signal indication 211 simultaneously indicates both a straight ahead signal and a left turn signal along the one direction, a second signal indication 212 simultaneously indicates both a straight ahead signal and a left turn signal along the other direction, a third signal indication 213 simultaneously indicates both a straight ahead signal and a left turn signal along the downward direction, and a fourth signal indication 214 simultaneously indicates both a straight ahead signal and a left turn signal along the upward direction, and in which the signal indication values of the first signal indication 211, second signal indication 212, third signal indication 213, and fourth signal indication 214 are 35 to 37 seconds, 43 to 45 seconds, 19 to 21 seconds, and 19 to 21 seconds, respectively.

In accordance with another embodiment of the present invention, an intersection signal system based on a distance between intersections includes a first intersection 120, a second intersection 220 located 900 to 1100 m away from the first intersection 110 in the other direction, first traffic lights 120S provided in the first intersection 110, and second traffic lights 210S provided in the second intersection 220, in which, in the first traffic lights 120S, a first signal indication 121 simultaneously indicates both a straight ahead signal and a left turn signal along one direction, a second signal indication 122 simultaneously indicates both a straight ahead signal and a left turn signal along the other direction, a third signal indication 123 simultaneously indicates both a straight ahead signal and a left turn signal along a downward direction, and a fourth signal indication 124 simultaneously indicates both a straight ahead signal and a left turn signal in an upward direction, in which signal indication values of the first signal indication 121, second signal indication 122, third signal indication 123, and fourth signal indication 124 are 35 to 37 seconds, 43 to 45 seconds, 19 to 21 seconds, and 19 to 21 seconds, respectively, in which, in the second traffic lights 220S, a first signal indication 212 simultaneously indicates both a straight ahead signal and a left turn signal along the one direction, a second signal indication 222 simultaneously indicates both a straight ahead signal and a left turn signal along the downward direction, a third signal indication 223 simultaneously indicates both a straight ahead signal and a left turn signal along the other direction, and a fourth signal indication 224 simultaneously indicates both a straight ahead signal and a left turn signal along the upward direction, and in which the signal indication values of the first signal indication 221, second signal indication 222, third signal indication 223, and fourth signal indication 224 are 35 to 37 seconds, 23 to 25 seconds, 39 to 41 seconds, and 19 to 21 seconds, respectively.

In accordance with still another embodiment of the present invention, an intersection signal system based on a distance between intersections includes a first intersection 130, a second intersection 230 located 220 to 280 m away from the first intersection 130 in the other direction, first traffic lights 130S provided in the first intersection 130, and second traffic lights 230S provided in the second intersection 230, in which, in the first traffic lights 130S, a first signal indication 131 simultaneously indicates both a straight ahead signal and a left turn signal along one direction, a second signal indication 132 simultaneously indicates both a straight ahead signal and a left turn signal along the other direction, a third signal indication 133 simultaneously indicates both a straight ahead signal and a left turn signal along a downward direction, and a fourth signal indication 134 simultaneously indicates both a straight ahead signal and a left turn signal along an upward direction, in which signal indication values of the first signal indication 131, second signal indication 132, third signal indication 133, and fourth signal indication 134 are 39 to 41 seconds, 39 to 41 seconds, 19 to 21 seconds, and 19 to 21 seconds, respectively, in which, in the second traffic lights 210S, a first signal indication 231 simultaneously indicates both a straight ahead signal and a left turn signal along the other direction, a second signal indication 232 simultaneously indicates both a straight ahead signal and a left turn signal along the one direction, a third signal indication 233 simultaneously indicates both a straight ahead signal and a left turn signal along the upward direction, and a fourth signal indication 134 simultaneously indicates both a straight ahead signal and a left turn signal along the downward direction, and in which the signal indication values of the first signal indication 131, second signal indication 132, third signal indication 133, and fourth signal indication 134 are 43 to 45 seconds, 35 to 37 seconds, 39 to 41 seconds, and 19 to 21 seconds, respectively.

In accordance with still yet another embodiment of the present invention, an intersection signal system based on a distance between intersections includes a first intersection 220, a second intersection 240 located 450 to 550 m away from the first intersection 220 in the other direction, first traffic lights 220S provided in the first intersection 220, and second traffic lights 240S provided in the second intersection 240, in which, in the first traffic lights 220S, a first signal indication 111 simultaneously indicates both a straight ahead signal and a left turn signal along one direction, a second signal indication 222 simultaneously indicates both a straight ahead signal and a left turn signal along a downward direction, a third signal indication 223 simultaneously indicates both a straight ahead signal and a left turn signal along the other direction, and a fourth signal indication 224 simultaneously indicates both a straight ahead signal and a left turn signal along an upward direction, in which signal indication values of the first signal indication 221, second signal indication 222, third signal indication 223, and fourth signal indication 224 are 35 to 37 seconds, 23 to 25 seconds, 39 to 41 seconds, and 19 to 21 seconds, respectively, in which, in the second traffic lights 240S, a first signal indication 241 simultaneously indicates both a straight ahead signal and a left turn signal along the one direction, a second signal indication 242 simultaneously indicates both a straight ahead signal and a left turn signal along the other direction, a third signal indication 243 simultaneously indicates both a straight ahead signal and a left turn signal along the downward direction, and a fourth signal indication 244 simultaneously indicates both a straight ahead signal and a left turn signal along the upward direction, and in which the signal indication values of the first signal indication 241, second signal indication 242, third signal indication 243, and fourth signal indication 244 are 39 to 41 seconds, 39 to 41 seconds, 19 to 21 seconds, and 19 to 21 seconds, respectively.

In the embodiment of the present invention, it is preferable that the intersection signal system may include an intersection 250 located 900 to 1100 m away from the first intersection 220 in one direction, and traffic lights 250S provided in the intersection 250, in which, in the first traffic lights 250S, a first signal indication 251 may simultaneously indicate both a straight ahead signal and a left turn signal along one direction, a second signal indication 252 may simultaneously indicate a straight ahead signal and a left turn signal along the other direction, a third signal indication 253 may simultaneously indicate both a straight ahead signal and a left turn signal along a downward direction, and a fourth signal indication 254 may simultaneously indicate both a straight ahead signal and a left turn signal along an upward direction, and in which signal indication values of the first signal indication 251, second signal indication 252, third signal indication 253, and fourth signal indication 254 may be 35 to 37 seconds, 43 to 45 seconds, 19 to 21 seconds, and 19 to 21 seconds, respectively, [ [symbol] ][14] The intersection signal phasing system based on the distance between intersections according to the present invention displays the straight ahead signal and the left turn signal as simultaneous signals on all directions of one direction, the other direction, the upward direction, and the downward direction, and sets a signal indication value according to a distance to a subsequent intersection, thereby inducing efficient traffic flow.

### Advantageous Effects

The intersection signal phasing system based on the distance between intersections according to the present invention displays the straight ahead signal and the left turn signal as simultaneous signals on all directions of one direction, the other direction, the upward direction, and the downward direction, and sets a signal indication value according to a distance to a subsequent intersection, thereby inducing efficient traffic flow.

### BRIEF DESCRIPTION OF THE DRAWINGS

FIG. 1 is a diagram showing signal indications and signal indication values at a general intersection;

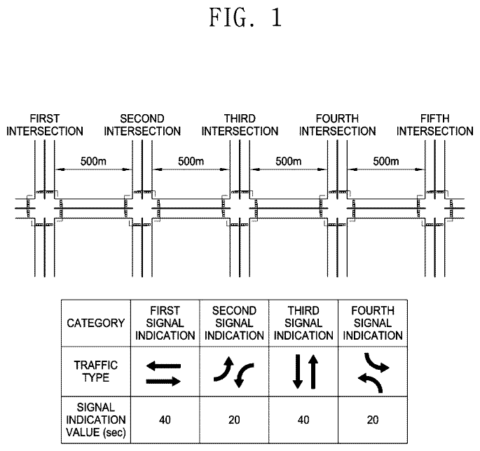

FIG. 2 is a diagram illustrating a signal phasing system in which a distance between two intersections is 500 m according to an embodiment of the present invention;

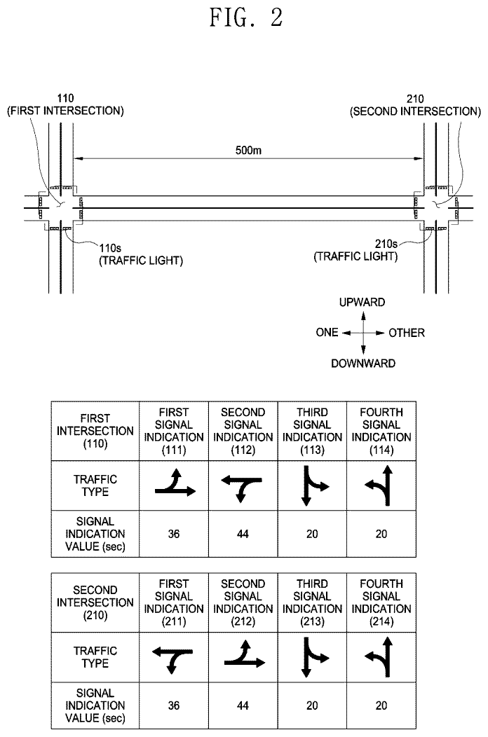

FIG. 3 is a diagram illustrating a signal phasing system in which a distance between two intersections is 1,000 m according to an embodiment of the present invention;

FIG. 4 is a diagram illustrating a signal phasing system in which a distance between two intersections is 250 m according to an embodiment of the present invention;

FIG. 5 is a diagram illustrating a signal phasing system in a case where a distance between intersections is 500 m and another intersection is formed by being spaced apart from 1000 m in one direction from an intersection formed on one side according to an embodiment of the present invention;

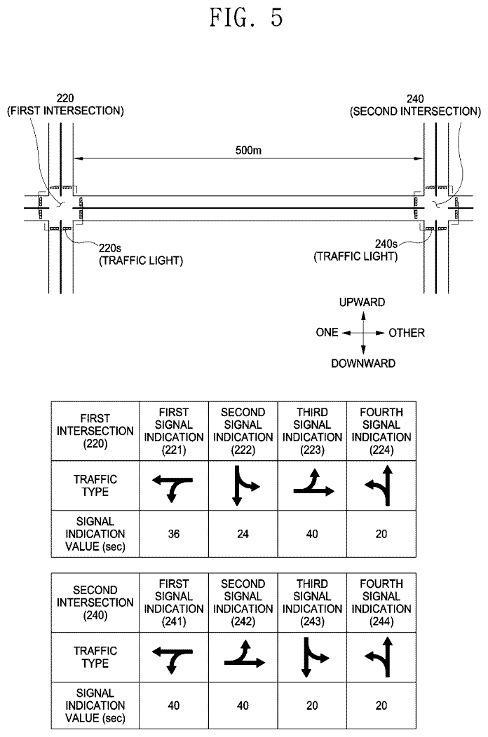

FIG. 6 is a diagram illustrating a signal phasing system in which three intersections are formed and distances between the three intersections are 1,000 m and 500 m, respectively, according to an embodiment of the present invention;

FIG. 7 is a diagram illustrating a traffic volume measurement simulation that reflects a conventional traffic system; and

FIG. 8 is a diagram illustrating a traffic volume measurement simulation diagram reflecting a traffic system according to an embodiment of the present invention.

### MODE FOR CARRYING OUT THE INVENTION

Embodiments of an intersection signal phasing system based on a distance between intersections according to the present invention will be described in detail with reference to the accompanying drawings. In the description with reference to the accompanying drawings, the same or corresponding components are assigned the same reference numerals and redundant descriptions thereof will be omitted.

In addition, terms such as first, second, etc. used below are merely identification symbols for distinguishing the same or corresponding components, and the same or corresponding components are not limited by the terms such as first, second, etc.

In addition, the coupling is to be used as a concept that does not only mean the case where, in a contact relationship between components, there is direct physical contact between the components but also includes cases where another component is interposed between components and the other component is in contact with each of the components.

Hereinafter, an intersection signal phasing system based on a distance between intersections according to an embodiment of the present invention will be described in detail with reference to the accompanying table and drawings.

An intersection signal system based on a distance between intersections according to the present invention includes a first intersection 110, a second intersection 210 located 450 to 550 m away from the first intersection 110 in the other direction, first traffic lights 110S provided in the first intersection 110; and second traffic lights 210S provided in the second intersection 210, in which, in the first traffic lights 110S, a first signal indication 111 simultaneously indicates both a straight ahead signal and a left turn signal along the other direction, a second signal indication 112 simultaneously indicates both a straight ahead signal and a left turn signal along one direction, a third signal indication 113 simultaneously indicates both a straight ahead signal and a left turn signal along a downward direction, and a fourth signal indication 114 simultaneously indicates both a straight ahead signal and a left turn signal in an upward direction, in which signal indication values of the first signal indication 111, second signal indication 112, third signal indication 113, and fourth signal indication 114 are 35 to 37 seconds, 43 to 45 seconds, 19 to 21 seconds, and 19 to 21 seconds, respectively, in which in the second traffic lights 210S, a first signal indication 211 simultaneously indicates both a straight ahead signal and a left turn signal along the one direction, a second signal indication 212 simultaneously indicates both a straight ahead signal and a left turn signal along the other direction, a third signal indication 213 simultaneously indicates both a straight ahead signal and a left turn signal along the downward direction, and a fourth signal indication 214 simultaneously indicates both a straight ahead signal and a left turn signal along the upward direction, and in which the signal indication values of the first signal indication 211, second signal indication 212, third signal indication 213, and fourth signal indication 214 are 35 to 37 seconds, 43 to 45 seconds, 19 to 21 seconds, and 19 to 21 seconds, respectively.

In general, signal control at intersections on urban arterial roads is usually operated with a signal system that involves going straight ahead in both directions and then turning left (straight ahead-first separate signal). During commuting to and from work, it is generally operated to handle traffic volume by being operated with a traffic increased direction (one direction) interoperating system during commuting to and from work, but there is a problem with the existing straight ahead-first separate signal that it cannot satisfy an interoperation system between both directions (upbound/downbound) by a separation distance between intersections (separation time) and an intersection traffic signal lighting interval (OFFset).

The present invention is a signal phasing system that maximizes an interoperation width between both directions, and a common period is set to 120 seconds, a signal indication for a main direction is set to around 40 seconds, and a signal indication for a secondary direction is set to around 20 seconds. The road speed was set at 50 km/h on main roads in accordance with the National Police Agency's Safety Policy 5030.

In order to maximize the interoperation width between both directions, straight-ahead and left-turn simultaneous signals were applied rather than straight-ahead and left-turn separate signals, and a signal indication pattern, signal indication rate, and interoperation value-relative time value for each intersection where the main signal indication is lighted according to the separation distance (time) between intersections were calculated.

A case where the separation time between intersections is less than ½ of the common period corresponds to a case where the separation time between two intersections is 60 seconds, which is half of the common period of 120 seconds, or less.

If the separation distance is 500 m and the road speed is 50 km/h, the separation time is 36 seconds.

$$separation time value ( t , sec ) = \frac{0.5 km}{50 km / h} * 3600$$

If the signal indication order of handling in both directions (upbound/downbound) at two intersections is reversed and is lighted and the interoperation values between two intersections are made the same, the interoperation width can be maximized. If the first signal indication is calculated as the separation time (36 seconds), the traffic volume handled at each intersection can be reduced, but the stopping time is reduced, and thus the travel time in both directions tends to increase.

An intersection signal system based on a distance between intersections according to another embodiment of the present invention includes a first intersection 120, a second intersection 220 located 900 to 1100 m away from the first intersection 110 in the other direction, first traffic lights 120S provided in the first intersection 110, and second traffic lights 210S provided in the second intersection 220, in which, in the first traffic lights 120S, a first signal indication 121 simultaneously indicates both a straight ahead signal and a left turn signal along one direction, a second signal indication 122 simultaneously indicates both a straight ahead signal and a left turn signal along the other direction, a third signal indication 123 simultaneously indicates both a straight ahead signal and a left turn signal along a downward direction, and a fourth signal indication 124 simultaneously indicates both a straight ahead signal and a left turn signal in an upward direction, in which signal indication values of the first signal indication 121, second signal indication 122, third signal indication 123, and fourth signal indication 124 are 35 to 37 seconds, 43 to 45 seconds, 19 to 21 seconds, and 19 to 21 seconds, respectively, in which, in the second traffic lights 220S, a first signal indication 212 simultaneously indicates both a straight ahead signal and a left turn signal along the one direction, a second signal indication 222 simultaneously indicates both a straight ahead signal and a left turn signal along the downward direction, a third signal indication 223 simultaneously indicates both a straight ahead signal and a left turn signal along the other direction, and a fourth signal indication 224 simultaneously indicates both a straight ahead signal and a left turn signal along the upward direction, and in which the signal indication values of the first signal indication 221, second signal indication 222, third signal indication 223, and fourth signal indication 224 are 35 to 37 seconds, 23 to 25 seconds, 39 to 41 seconds, and 19 to 21 seconds, respectively.

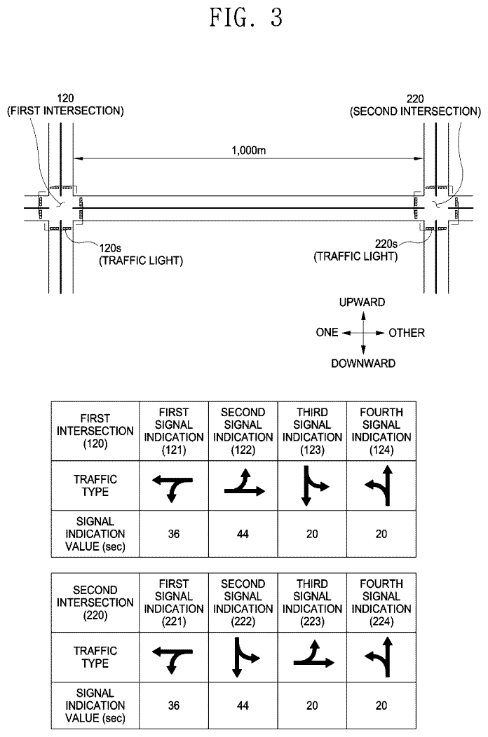

In this case, it is implemented with a signal indication pattern and a signal indication values as shown in FIG. 3.

In this case, it is implemented with the signal indication patterns and signal indication values as shown in FIG. 3. If the separation time between two intersections is ½ (60 seconds) of 120 seconds, which is a common period, or more, traffic handling is degraded when distributed to one standard signal indication.

If the separation distance is 1,000 m and the road speed is 50 km/h, the separation time is 72 seconds.

$$separation time value ( t , sec ) = \frac{0.5 km}{50 km / h} * 3600$$

The interoperation value of the second traffic light 220S to the second intersection 220 is 48 seconds.

A downbound processing signal at two intersections is lighted with the first signal indication, a processing signal at an upbound departure intersection is lighted with the second signal indication, and a processing signal at an upbound arrival intersection is lighted with the third signal indication and a difference in interoperation values between two intersections is set to be equal to the separation time, the interoperation width between both directions can be increased to the maximum.

If the order of signal indications is kept the same and the signal indications at one intersection are lighted with alternate signal indications (first and third indications), the traffic volume handled at each intersection can be reduced, but the stopping time is reduced and the travel time in both directions is significantly increased.

An intersection signal system based on a distance between intersections according to still another embodiment of the present invention includes a first intersection 130, a second intersection 230 located 220 to 280 m away from the first intersection 130 in the other direction, first traffic lights 130S provided in the first intersection 130, and second traffic lights 230S provided in the second intersection 230, in which, in the first traffic lights 130S, a first signal indication 131 simultaneously indicates both a straight ahead signal and a left turn signal along one direction, a second signal indication 132 simultaneously indicates both a straight ahead signal and a left turn signal along the other direction, a third signal indication 133 simultaneously indicates both a straight ahead signal and a left turn signal along a downward direction, and a fourth signal indication 134 simultaneously indicates both a straight ahead signal and a left turn signal along an upward direction, in which signal indication values of the first signal indication 131, second signal indication 132, third signal indication 133, and fourth signal indication 134 are 39 to 41 seconds, 39 to 41 seconds, 19 to 21 seconds, and 19 to 21 seconds, respectively, in which, in the second traffic lights 210S, a first signal indication 231 simultaneously indicates both a straight ahead signal and a left turn signal along the other direction, a second signal indication 232 simultaneously indicates both a straight ahead signal and a left turn signal along the one direction, a third signal indication 233 simultaneously indicates both a straight ahead signal and a left turn signal along the upward direction, and a fourth signal indication 134 simultaneously indicates both a straight ahead signal and a left turn signal along the downward direction, and in which the signal indication values of the first signal indication 131, second signal indication 132, third signal indication 133, and fourth signal indication 134 are 43 to 45 seconds, 35 to 37 seconds, 39 to 41 seconds, and 19 to 21 seconds, respectively.

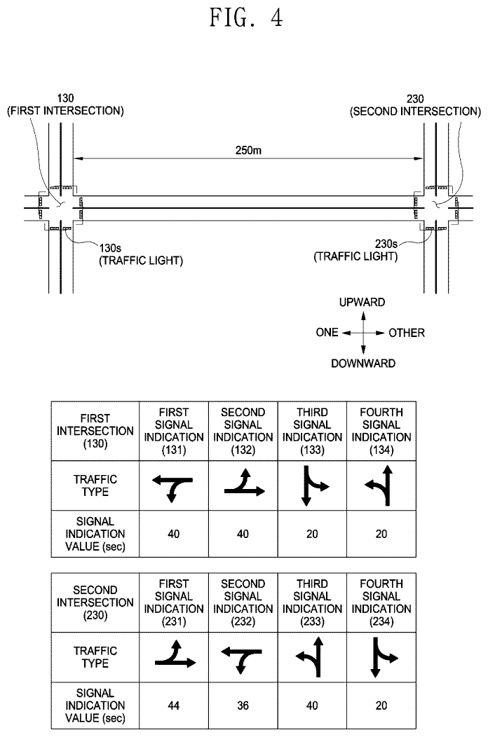

In this case, as shown in FIG. 4, if the separation time between two intersections is less than ¼ (30 seconds) of 120 seconds, which is the common period, traffic volume handling is degraded when distributed to one standard indication based on the separation distance.

If the separation distance is 250 m and the road speed is 50 km/h, the separation time is 18 seconds.

$$separation time value ( t , sec ) = \frac{0.5 km}{50 km / h} * 3600$$

The signal indication order of handling in both directions (upbound/downbound) at two intersections is reversed and is lighted.

The interoperation value of the first intersection 130 is −2, and the interoperation value of the second intersection 230 is 56 seconds obtained by adding the first signal indication of the first intersection+separation time+interoperation value (40 seconds+18 seconds−2).

The first signal indication value of the second intersection 230 is 44 seconds (118 seconds−56 seconds−18 seconds=44 seconds) as first intersection interoperation value-second intersection interoperation value-separation time.

An intersection signal system based on a distance between intersections according to still yet another embodiment of the present invention includes a first intersection 220, a second intersection 240 located 450 to 550 m away from the first intersection 220 in the other direction, first traffic lights 220S provided in the first intersection 220, and second traffic lights 240S provided in the second intersection 240, in which, in the first traffic lights 220S, a first signal indication 111 simultaneously indicates both a straight ahead signal and a left turn signal along one direction, a second signal indication 222 simultaneously indicates both a straight ahead signal and a left turn signal along a downward direction, a third signal indication 223 simultaneously indicates both a straight ahead signal and a left turn signal along the other direction, and a fourth signal indication 224 simultaneously indicates both a straight ahead signal and a left turn signal along an upward direction, in which signal indication values of the first signal indication 221, second signal indication 222, third signal indication 223, and fourth signal indication 224 are 35 to 37 seconds, 23 to 25 seconds, 39 to 41 seconds, and 19 to 21 seconds, respectively, in which, in the second traffic lights 240S, a first signal indication 241 simultaneously indicates both a straight ahead signal and a left turn signal along the one direction, a second signal indication 242 simultaneously indicates both a straight ahead signal and a left turn signal along the other direction, a third signal indication 243 simultaneously indicates both a straight ahead signal and a left turn signal along the downward direction, and a fourth signal indication 244 simultaneously indicates both a straight ahead signal and a left turn signal along the upward direction, and in which the signal indication values of the first signal indication 241, second signal indication 242, third signal indication 243, and fourth signal indication 244 are 39 to 41 seconds, 39 to 41 seconds, 19 to 21 seconds, and 19 to 21 seconds, respectively.

It is preferable that the intersection signal system includes an intersection 250 located 900 to 1100 m away from the first intersection 220 in one direction, and traffic lights 250S provided in the intersection 250, in which, in the first traffic lights 250S, a first signal indication 251 simultaneously indicates both a straight ahead signal and a left turn signal along one direction, a second signal indication 252 simultaneously indicates a straight ahead signal and a left turn signal along the other direction, a third signal indication 253 simultaneously indicates both a straight ahead signal and a left turn signal along a downward direction, and a fourth signal indication 254 simultaneously indicates both a straight ahead signal and a left turn signal along an upward direction, and in which signal indication values of the first signal indication 251, second signal indication 252, third signal indication 253, and fourth signal indication 254 are 35 to 37 seconds, 43 to 45 seconds, 19 to 21 seconds, and 19 to 21 seconds, respectively.

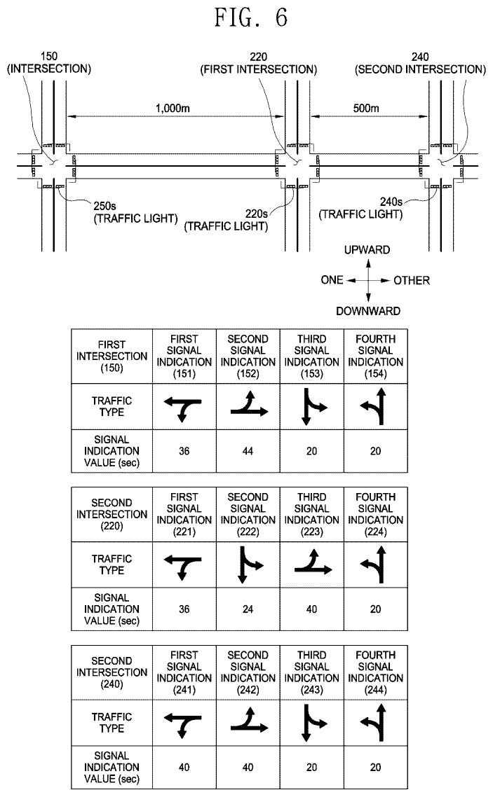

In this case, as shown in FIG. 6, in a case where alternate signal indications (lighting of first and third indications) and continuous signal indications (lighting of first and second indications) are adjacent, when the signal indication for the main direction at the first intersection 220 is lighted at the first and third signal indications, and the signal indication for the main direction at the second intersection 240 is lighted at the first and second signal indications, it can be a signal plan to maximize the interoperation width between both directions.

If the separation distance is 500 m and the road speed is 50 km/h, the separation time is 36 seconds.

$$separation time value ( t , sec ) = \frac{0.5 km}{50 km / h} * 3600$$

It was set that continuous signal indication intersection (second intersection 240) upbound waiting time=(continuous signal indication intersection (second intersection 240) interoperation value+first signal indication)−(alternate signal indication intersection (first intersection 240) interoperation value+first signal indication+second signal indication+separation time)=(120 seconds+40 seconds)−(0 seconds+40 seconds+20 seconds+36 seconds)=160 seconds−96 seconds=64 seconds,
alternate signal indication intersection (first intersection 220) downbound waiting time=(alternate signal indication intersection (first intersection 220) interoperation value)−(continuous signal indication intersection (second intersection 240) interoperation value)+separation distance)=120 seconds−36 seconds=84 seconds,
continuous signal indication intersection adjustment interoperation value=(alternate signal indication interoperation value)+(period/2)+(|upbound waiting time−downbound waiting time|/2)=48 seconds+60 seconds+10 seconds=118 seconds, and
continuous signal indication intersection upward adjustment waiting time=(continuous signal indication intersection interoperation value+first signal indication)−(alternate signal indication intersection interoperation value+first signal indication+second signal indication+separation distance)=(118 seconds+40 seconds)−(48 seconds+36 seconds+24 seconds+36 seconds)=158 seconds−144 seconds=14 seconds, and
alternate signal indication intersection downbound adjustment waiting time=(alternate signal indication intersection interoperation value)−(continuous signal indication intersection interoperation value+separation distance)=48 seconds−(−2 seconds+36 seconds)=14 seconds.

The waiting times and interoperation value are set as above.

When applying the present invention, if the simultaneous signal of the interoperation system between both directions, which is the idea of the present invention, is operated compared to when operating the existing straight-first separate signal for five intersections per axis, an average travel time decreases by 64 seconds (27%), and an average travel speed increases by 12.3 km/h (36%). In addition, it has the effect of reducing the number of stops by one.

Table 1 below shows the calculated and compared travel times, travel speeds, and number of stops according to the embodiment to which the present invention is applied and the comparative example, which is a conventional traffic signal system.

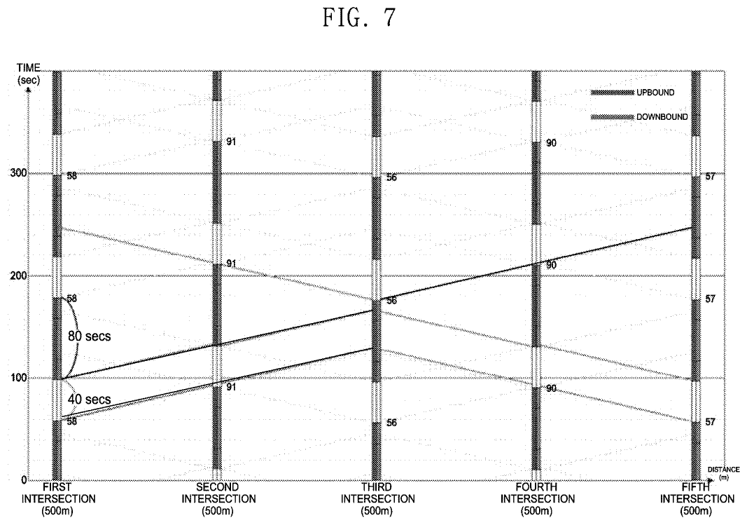

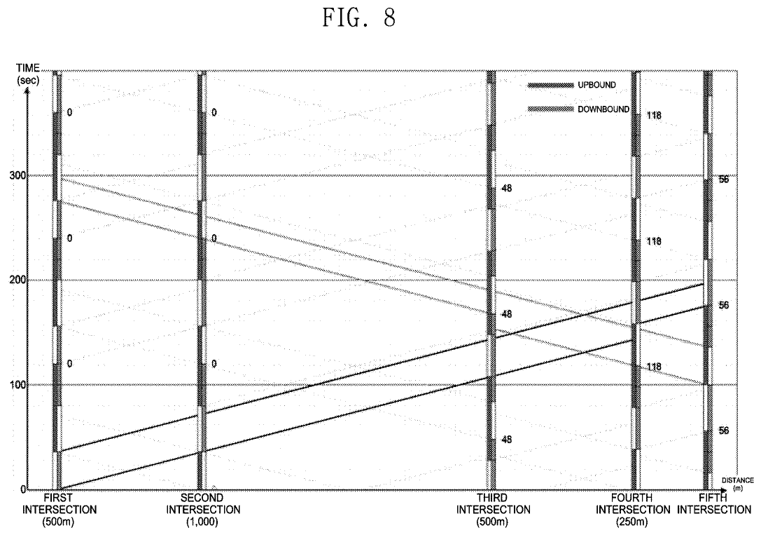

The driving simulation diagram is shown in FIGS. 7 and 8.

TABLE 1

| | Travel time (seconds) | | Travel speed (km/h) | | Number of stops (times) | |
|---|---|---|---|---|---|---|
| Category | Upward | Downward | Upward | Downward | Upward | Downward |
| Comparative example | 239 | 241 | 33.9 | 33.6 | 2 | 2 |
| Embodiment | 176 | 176 | 46.0 | 46.0 | 1 | 1 |
| Increase/Decrease | −63(26%) | −65(27%) | 12.1(36%) | 12.4(37%) | −1(50%) | −1(50%) |

1. An intersection signal system based on a distance between intersections comprising:
a first intersection 110;
a second intersection 210 located 450 to 550 m away from the first intersection 110 in the other direction;
first traffic lights 110S provided in the first intersection 110; and
second traffic lights 210S provided in the second intersection 210,
wherein, in the first traffic lights 110S,
a first signal indication 111 simultaneously indicates both a straight ahead signal and a left turn signal along the other direction,
a second signal indication 112 simultaneously indicates both a straight ahead signal and a left turn signal along one direction,
a third signal indication 113 simultaneously indicates both a straight ahead signal and a left turn signal along a downward direction, and
a fourth signal indication 114 simultaneously indicates both a straight ahead signal and a left turn signal in an upward direction,
wherein signal indication values of the first signal indication 111, second signal indication 112, third signal indication 113, and fourth signal indication 114 are 35 to 37 seconds, 43 to 45 seconds, 19 to 21 seconds, and 19 to 21 seconds, respectively,
wherein, in the second traffic lights 210S,
a first signal indication 211 simultaneously indicates both a straight ahead signal and a left turn signal along the one direction,
a second signal indication 212 simultaneously indicates both a straight ahead signal and a left turn signal along the other direction,
a third signal indication 213 simultaneously indicates both a straight ahead signal and a left turn signal along the downward direction, and
a fourth signal indication 214 simultaneously indicates both a straight ahead signal and a left turn signal along the upward direction, and
wherein the signal indication values of the first signal indication 211, second signal indication 212, third signal indication 213, and fourth signal indication 214 are 35 to 37 seconds, 43 to 45 seconds, 19 to 21 seconds, and 19 to 21 seconds, respectively.

2. An intersection signal system based on a distance between intersections comprising:
a first intersection 120;
a second intersection 220 located 900 to 1100 m away from the first intersection 110 in the other direction;
first traffic lights 120S provided in the first intersection 110; and
second traffic lights 210S provided in the second intersection 220,
wherein, in the first traffic lights 120S,
a first signal indication 121 simultaneously indicates both a straight ahead signal and a left turn signal along one direction,
a second signal indication 122 simultaneously indicates both a straight ahead signal and a left turn signal along the other direction,
a third signal indication 123 simultaneously indicates both a straight ahead signal and a left turn signal along a downward direction, and
a fourth signal indication 124 simultaneously indicates both a straight ahead signal and a left turn signal in an upward direction,
wherein signal indication values of the first signal indication 121, second signal indication 122, third signal indication 123, and fourth signal indication 124 are 35 to 37 seconds, 43 to 45 seconds, 19 to 21 seconds, and 19 to 21 seconds, respectively,
wherein, in the second traffic lights 220S,
a first signal indication 212 simultaneously indicates both a straight ahead signal and a left turn signal along the one direction,
a second signal indication 222 simultaneously indicates both a straight ahead signal and a left turn signal along the downward direction,
a third signal indication 223 simultaneously indicates both a straight ahead signal and a left turn signal along the other direction, and
a fourth signal indication 224 simultaneously indicates both a straight ahead signal and a left turn signal along the upward direction, and
wherein the signal indication values of the first signal indication 221, second signal indication 222, third signal indication 223, and fourth signal indication 224 are 35 to 37 seconds, 23 to 25 seconds, 39 to 41 seconds, and 19 to 21 seconds, respectively.

3. An intersection signal system based on a distance between intersections comprising:
a first intersection 130;
a second intersection 230 located 220 to 280 m away from the first intersection 130 in the other direction;
first traffic lights 130S provided in the first intersection 130; and
second traffic lights 230S provided in the second intersection 230,
wherein, in the first traffic lights 130S,
a first signal indication 131 simultaneously indicates both a straight ahead signal and a left turn signal along one direction,
a second signal indication 132 simultaneously indicates both a straight ahead signal and a left turn signal along the other direction,
a third signal indication 133 simultaneously indicates both a straight ahead signal and a left turn signal along a downward direction, and
a fourth signal indication 134 simultaneously indicates both a straight ahead signal and a left turn signal along an upward direction,
wherein signal indication values of the first signal indication 131, second signal indication 132, third signal indication 133, and fourth signal indication 134 are 39 to 41 seconds, 39 to 41 seconds, 19 to 21 seconds, and 19 to 21 seconds, respectively,
wherein, in the second traffic lights 210S,
a first signal indication 231 simultaneously indicates both a straight ahead signal and a left turn signal along the other direction,
a second signal indication 232 simultaneously indicates both a straight ahead signal and a left turn signal along the one direction,
a third signal indication 233 simultaneously indicates both a straight ahead signal and a left turn signal along the upward direction, and
a fourth signal indication 134 simultaneously indicates both a straight ahead signal and a left turn signal along the downward direction, and
wherein the signal indication values of the first signal indication 131, second signal indication 132, third signal indication 133, and fourth signal indication 134 are 43 to 45 seconds, 35 to 37 seconds, 39 to 41 seconds, and 19 to 21 seconds, respectively.

4. An intersection signal system based on a distance between intersections comprising:
a first intersection 220;
a second intersection 240 located 450 to 550 m away from the first intersection 220 in the other direction;
first traffic lights 220S provided in the first intersection 220; and
second traffic lights 240S provided in the second intersection 240,
wherein, in the first traffic lights 220S,
a first signal indication 111 simultaneously indicates both a straight ahead signal and a left turn signal along one direction,
a second signal indication 222 simultaneously indicates both a straight ahead signal and a left turn signal along a downward direction,
a third signal indication 223 simultaneously indicates both a straight ahead signal and a left turn signal along the other direction, and
a fourth signal indication 224 simultaneously indicates both a straight ahead signal and a left turn signal along an upward direction,
wherein signal indication values of the first signal indication 221, second signal indication 222, third signal indication 223, and fourth signal indication 224 are 35 to 37 seconds, 23 to 25 seconds, 39 to 41 seconds, and 19 to 21 seconds, respectively,
wherein, in the second traffic lights 240S,
a first signal indication 241 simultaneously indicates both a straight ahead signal and a left turn signal along the one direction,
a second signal indication 242 simultaneously indicates both a straight ahead signal and a left turn signal along the other direction,
a third signal indication 243 simultaneously indicates both a straight ahead signal and a left turn signal along the downward direction, and
a fourth signal indication 244 simultaneously indicates both a straight ahead signal and a left turn signal along the upward direction, and
wherein the signal indication values of the first signal indication 241, second signal indication 242, third signal indication 243, and fourth signal indication 244 are 39 to 41 seconds, 39 to 41 seconds, 19 to 21 seconds, and 19 to 21 seconds, respectively.

5. The intersection signal system of claim 1, further comprising:
an intersection 250 located 900 to 1100 m away from the first intersection 220 in one direction, and
traffic lights 250S provided in the intersection 250,
wherein, in the first traffic lights 250S,
a first signal indication 251 simultaneously indicates both a straight ahead signal and a left turn signal along one direction,
a second signal indication 252 simultaneously indicates a straight ahead signal and a left turn signal along the other direction,
a third signal indication 253 simultaneously indicates both a straight ahead signal and a left turn signal along a downward direction, and
a fourth signal indication 254 simultaneously indicates both a straight ahead signal and a left turn signal along an upward direction, and
wherein signal indication values of the first signal indication 251, second signal indication 252, third signal indication 253, and fourth signal indication 254 are 35 to 37 seconds, 43 to 45 seconds, 19 to 21 seconds, and 19 to 21 seconds, respectively.
